(19) United States
(12) Patent Application Publication
(10) Pub. No.: US 2016/0351061 A1
(43) Pub. Date: Dec. 1, 2016

(54) ELECTRIC GREEN TAXIING SYSTEM (EGTS) PROXIMITY SENSING SYSTEM FOR AIRCRAFT ANTI-COLLISION

(71) Applicant: HONEYWELL INTERNATIONAL INC., MORRISTOWN, NJ (US)

(72) Inventors: Andrew F. Lamkin, Alberquerque, NM (US); Stephen D. Handel, Gilbert, AZ (US); Matthew Warpinski, Alberquerque, NM (US); Duke Buster, Alberquerque, NM (US)

(73) Assignee: HONEYWELL INTERNATIONAL INC., MORRISTOWN, NJ (US)

(21) Appl. No.: 14/727,227

(22) Filed: Jun. 1, 2015

(51) Int. Cl. G08G 5/06; G05D 1/00; B64D 45/00; B64C 25/42; B64C 25/40

(52) U.S. Cl. CPC G08G 5/065; B64C 25/42; B64C 25/405; B64D 45/00; G05D 1/0055; G05D 1/0011; B64D 2205/00

(57) ABSTRACT

A system and method for monitoring an aircraft during taxing on ground around an airport may include control of an engines-off taxiing system. The engines-off taxiing system may include a wireless handheld device having an aircraft stop pushbutton. The wireless handheld device may be carried by a wing-walker, and the associated aircraft stop pushbutton may be manually actuated by the wing-walker.

### BACKGROUND OF THE INVENTION

The present disclosure generally relates to systems and methods for monitoring an area proximate an aircraft during pushback of the aircraft from a terminal gate or stand. More particularly, the present disclosure relates to a system and method for monitoring an area proximate an aircraft during pushback of the aircraft using an engines-off taxiing system.

Crew in aircraft being pushed back from a gate of an airport terminal, or an associated docking area, currently have no way to monitor obstacles behind the aircraft. The crew in the aircraft are reliant on a ground crew, who are typically over-tasked with operating tugs, watching aircraft wings, and maintaining proper aircraft speed. Although strict control measures prohibit ground traffic behind an aircraft that is pushing back, collisions and accidents, which endanger the passengers, aircraft crew, and ground crew, continue to occur.

Terminal gate and ramp areas in today's airports can be very congested places, with simultaneously arriving and departing aircraft and ground service vehicles and ground personnel servicing and directing aircraft into and out of gates. Avoidance of collision incidents, in gate and ramp areas, requires careful monitoring and control of locations and movement of aircraft, and other vehicles as the aircraft and vehicles maneuver within the gate and ramp areas.

Pushback, of departing aircraft, is typically guided with even more care, because associated aircraft are moving in reverse, and neither a pilot nor flight crew are able to see the entire environment surrounding the aircraft. Sides and rear of the aircraft, in particular, cannot be seen by the pilot and crew from the cockpit. Currently, aircraft are pushed back with tow vehicles or tugs, and the tug driver is typically assisted by a number of ground personnel to guide and move the aircraft in reverse as it is simultaneously being turned to a location where the aircraft can start its engines and move forward to a taxiway.

At many, if not most, airports, the environment surrounding the aircraft is monitored by ground personnel and a tug driver, who communicate the aircraft status to the pilot through universal visual signals and, at some airports, through additional voice communications. Aircraft pushback, as presently conducted, is a time consuming and labor intensive process, that all too frequently produces delays in an airline's flight schedule.

Airport ground personnel are typically assigned to attach and detach tow vehicles and to monitor and direct reversing aircraft to ensure that no part of an aircraft structure will impact any fixed object, or other aircrafts or vehicles. Ground personnel may, in addition, communicate directly with a pilot or another aircraft cockpit crew member during an aircraft pushback process. Efficiency and speed, with which pushback can be conducted, often depends on availability of ground personnel as well as the availability of tow-vehicles.

Efficiency and speed of aircraft pushback operations tends to be adversely affected by the ground congestion found in most large airports. Multiple airlines concurrently conduct both pushback and arrival operations for multiple aircraft. This strains not only available towing equipment, but also the available ground personnel. Aircraft turnaround times may be increased significantly when tow bars, adapters, tugs, or ground crew personnel are not available for pushback when needed.

Driving an aircraft on the ground during taxi without reliance on operation of the aircraft's main engines or the use of tow-vehicles has been proposed. For example, in commonly assigned U.S. Patent Application Publication No. 20130038179, aircraft drive systems that use electric drive motors to power aircraft wheels, and move an aircraft on the ground, without reliance on aircraft main engines or tow-vehicles are described.

The associated engines-off self-pushback systems and methods may be designed for moving an aircraft, for example, parked in a nose-in orientation, along a reverse path while simultaneously turning the aircraft in the same direction and along the same path as the aircraft would be pushed back with a tug.

Sensors, including cameras and the like, have long been mounted on exterior locations on aircraft to monitor various aspects of an aircraft's exterior environment or an aircraft's ground maneuvers. For example, a camera system may be mounted to an aircraft to provide real time video images of the ground surrounding an aircraft nose or main landing gear to assist the aircraft pilot in maneuvering an aircraft with a wide wheel track, a long wheel base, or both during turns and gate entry. A plurality of strategically placed sensors may be employed, including video imaging generators, audio sensors, motion detectors, and smoke and fire detectors, primarily for remotely monitoring aircraft security, but also to monitor aircraft ground movement to avoid collisions when ground vehicles are outfitted with GPS receivers. Aircraft ground collision avoidance systems have also been described in the art. For example, a system of cameras may be mounted on an aircraft that use computer vision techniques to provide a live, dynamic map of an aircraft's surroundings to detect obstacles that might pose a collision threat to an aircraft moving on the ground. A caution or warning indication in the form of acoustic cues and visual information is provided to the aircraft's pilot when an obstacle is detected.

A need exists for a system or method for monitoring a streamlined, accelerated pushback process or autonomous reverse ground travel in an aircraft equipped with an engines-off taxiing system, wherein the aircraft is driven safely in reverse along an optimum path and turned at an angle that expedites pushback, so that it may then be driven forward for takeoff.

### SUMMARY OF THE INVENTION

In one aspect of the invention, an aircraft anti-collision system for use in taxiing an aircraft on a surface around an airport terminal includes a plurality of sensors communicatively coupled to a controller, wherein the plurality of sensors are configured to detect obstacles proximate the aircraft; and at least one first engines-off taxiing system and at least one second engines-off taxiing system communicatively couple to the controller, wherein the controller is configured to control the at least one first engines-off taxing system and the at least one second engines-off taxiing system to maneuver the aircraft in response to signals received, by the controller, from the plurality of sensors, wherein maneuvering the aircraft includes steering the aircraft by applying torque to at least one first landing gear wheel in a first direction via the at least one first engines-off taxing system, and applying torque to at least one second landing gear wheel in a second direction via the at least one second engines-off taxing system, wherein the first direction is rotationally opposite the second direction.

In another aspect of the invention, an aircraft anti-collision system for use in taxiing an aircraft on a surface around an airport terminal includes a plurality of sensors communicatively coupled to a controller, wherein the plurality of sensors are configured to detect obstacles proximate the aircraft; and at least one engines-off taxiing system communicatively couple to the controller, wherein the controller is configured to control the at least one engines-off taxing system to maneuver the aircraft in response to signals received, by the controller, from the plurality of sensors, wherein maneuvering the aircraft includes steering, stopping and accelerating the aircraft.

In a further aspect of the invention, an aircraft anti-collision system for use in taxiing an aircraft on a surface around an airport terminal includes a plurality of sensors communicatively coupled to a controller, wherein the plurality of sensors are configured to detect obstacles proximate the aircraft; at least one engines-off taxiing system communicatively couple to the controller, wherein the controller is configured to control the at least one engines-off taxing system to maneuver the aircraft in response to signals received, by the controller, from the plurality of sensors; and an emergency stop button that is configured to be activated by a ground crew individual in circumstances where collision of the aircraft with an obstacle is imminent, wherein the at least one engines-off taxiing system includes a hydraulic brake, and wherein activation of the emergency stop button activates the hydraulic brake.

These and other features, aspects and advantages of the present invention will become better understood with reference to the following drawings, description and claims.

### BRIEF DESCRIPTION OF THE DRAWINGS

FIG. 1 depicts a system for monitoring an aircraft in proximity of an airport terminal according to an exemplary embodiment of the present invention;

FIG. 2 depicts a system for monitoring an environment surrounding an aircraft according to an exemplary embodiment of the present invention;

FIG. 3A illustrates an implementation of an aircraft pushback method with no obstacles proximate the aircraft according to an exemplary embodiment of the present invention;

FIG. 3B illustrates an implementation of an aircraft pushback method with an obstacle coming into proximity of aircraft according to an exemplary embodiment of the present invention; and

FIG. 3C illustrates an implementation of an aircraft pushback method with an obstacle proximate the aircraft according to an exemplary embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

An associated aircraft stop may be triggered either completely autonomously, by an aircraft anti-collision system sensing an obstacle and commanding an engine off taxiing system to stop the aircraft, or manually by a wing walker seeing a potential obstacle and pressing a handheld button which may command the engine off taxiing system to stop the aircraft.

The systems and methods of the present disclosure may provide automatic collision avoidance during a critical stage of pushing back an aircraft from a gate at an airport terminal. Alternatively, or additionally, the systems and methods may provide ground crew-free aircraft pushback from the gate. In either situation, the present disclosure may also determine the whether an obstacle is at a height that is lower than a height of the aircraft structure, such as a wing, thus enabling the aircraft to safely pass over the obstacle rather than moving around the obstacle.

The present invention is intended to maximize pushback safety and minimize assistance from ground personnel, when a pushback method is employed, to minimize turnaround time. The present invention may quickly and efficiently move an aircraft in reverse from a nose-in parked location at a gate or terminal out of an obstructed apron area, and then may turn the aircraft in place, typically through a one-hundred-eighty degree turn, such that an associated pilot can drive the plane forward to a takeoff runway.

The present invention may potentially save at least one additional minute per pushback compared with the pushback of aircraft that are equipped with engines-off taxiing systems and travel in reverse along a traditional pushback path where the aircraft simultaneously turns as it moves in reverse. Compared with current pushback procedures using tugs with or without tow bars, this invention may save at least two to five minutes of turnaround time. The monitoring method of the present invention may be used to determine how far an aircraft must back up before a safe turn is possible.

As a result, no airport modifications are required to implement this streamlined accelerated pushback method. The entire autonomous accelerated pushback process, from the time the aircraft is driven in reverse out of the gate until it is turned around to drive away in a forward direction may take about a minute or less.

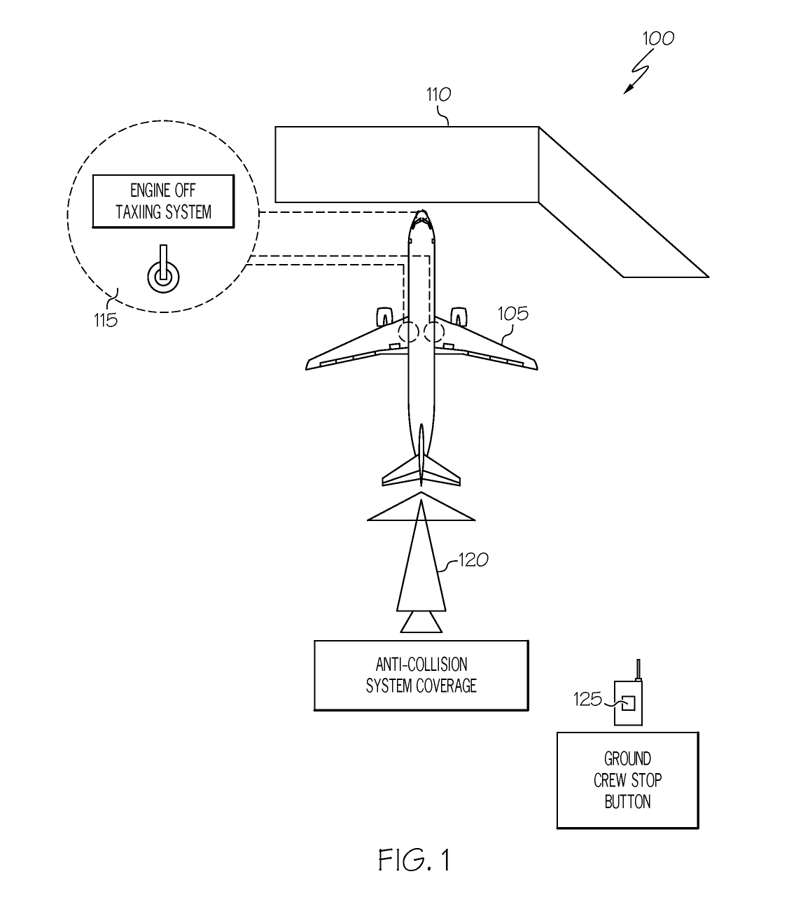

Turning to FIG. 1, an example system 100 for monitoring an aircraft 105 in proximity of an airport terminal 110 is depicted. The system 100 may include a ground crew (e.g., a wing-walker) mobile terminal 125 having an emergency stop button. The aircraft 105 may include at least one engines-off taxing system 115 and an anti-collision system 120. The aircraft 105 may include a single engines-off taxing system 115 on a nose landing gear. Alternatively, or additionally, the aircraft 105 may include an engines-off taxing system 105 on each of two main landing gear. The anti-collision system 120 may be configured to control the engines-off taxiing system 115 to automatically taxi the aircraft 105 backward, away from the terminal 110 and/or forward to an associated runway ready for takeoff. The emergency stop button of the mobile terminal 125 may be used by a ground crew, for example, to manually stop the aircraft 105. The systems and methods of the present disclosure may incorporate aircraft anti-collision systems, as described, for example, in commonly assigned U.S. Patent Application Publication Nos. 20130321194 and 20140062756, the disclosures of which are incorporated herein in their entireties by reference

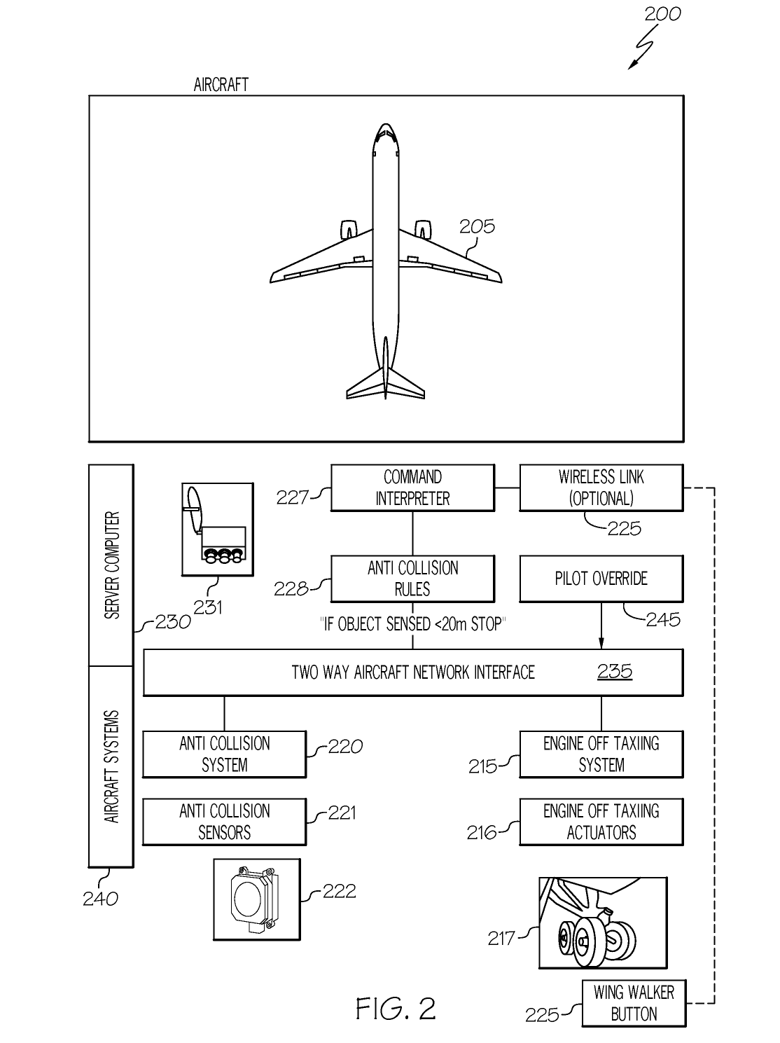

With reference to FIG. 2, an example system 200 for monitoring an environment surrounding an aircraft 205 may include a server computer 230, aircraft systems 240, and a wing walker button 225. The server computer 230 may include a wireless communication link 226, a command interpreter (e.g., a processor) 227, and anti-collision rules 228. The anti-collision rules 228 may be embodied in, for example, computer-readable instructions that, when executed by a processor, cause the processor to, for example, automatically maneuver the aircraft 205 to avoid collisions.

The server computer 230 may be incorporated into an aircraft system 231.

The aircraft systems 240 may include an anti-collision system 220 having anti-collision sensors 221 (e.g., sensor 222), and at least one engines-off taxing system 215 having engines-off taxing actuators (e.g., an actuator 217, a hydraulic brake and/or an electric motor).

An engines-off taxing system 215 may include an electric motor capable of providing torque to an associated landing gear wheel in either direction. Thereby, the electric motor may be used to move and/or stop the aircraft 205 under normal (e.g., non-emergency) circumstances. When an aircraft 205 includes an engines-off taxing system 215 on each of two main landing gear, the aircraft 205 may be maneuvered (automatically and/or manually) by selectively applying torque to associated lander gear wheels. For example, torque may be applied, to a right-hand set of landing gear wheels, in a first direction, using a first engines-off taxing system 215, and torque may be applied, to a left-hand set of landing gear wheels, in a second direction, using a second engines-off taxing system 215, such that the aircraft 205 is turned.

Additionally, or alternatively, an engines-off taxing system 215 may include a hydraulic brake. The emergency stop button of the mobile terminal 225 may be configured to activate the hydraulic brake in, for example, emergency circumstances (e.g., when a collision of the aircraft 205 is imminent). The aircraft systems 240 may be configured to prevent application of a hydraulic brake while applying torque via an engines-off taxing system 215.

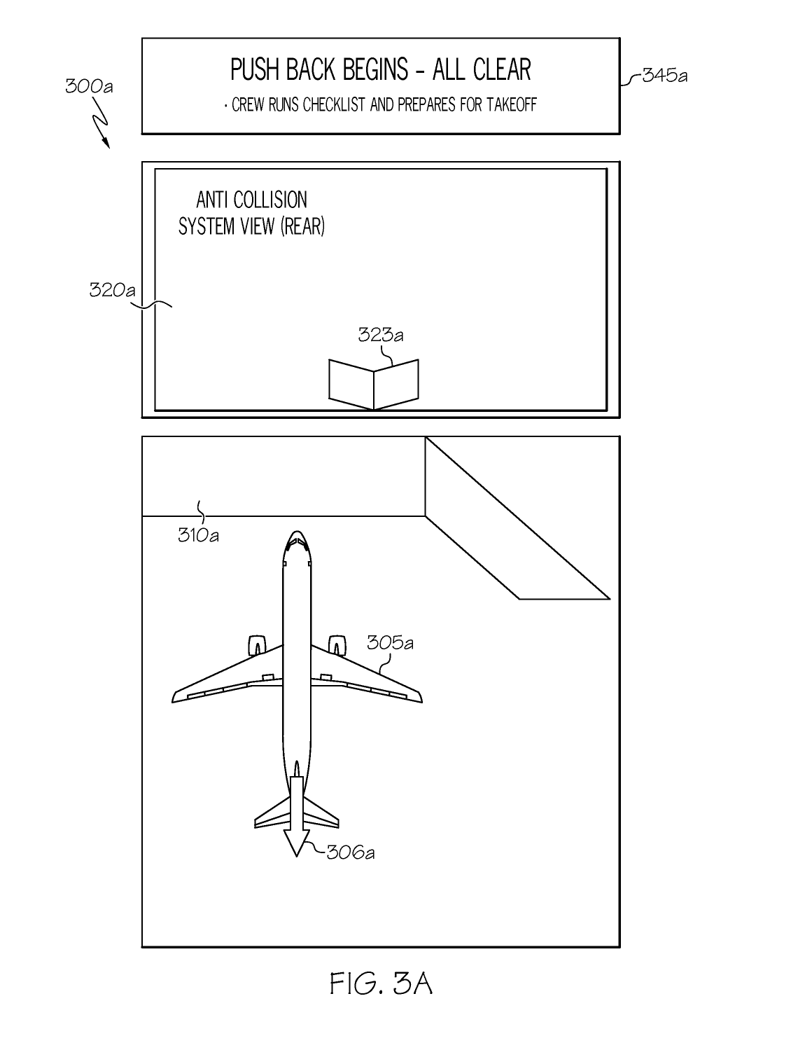

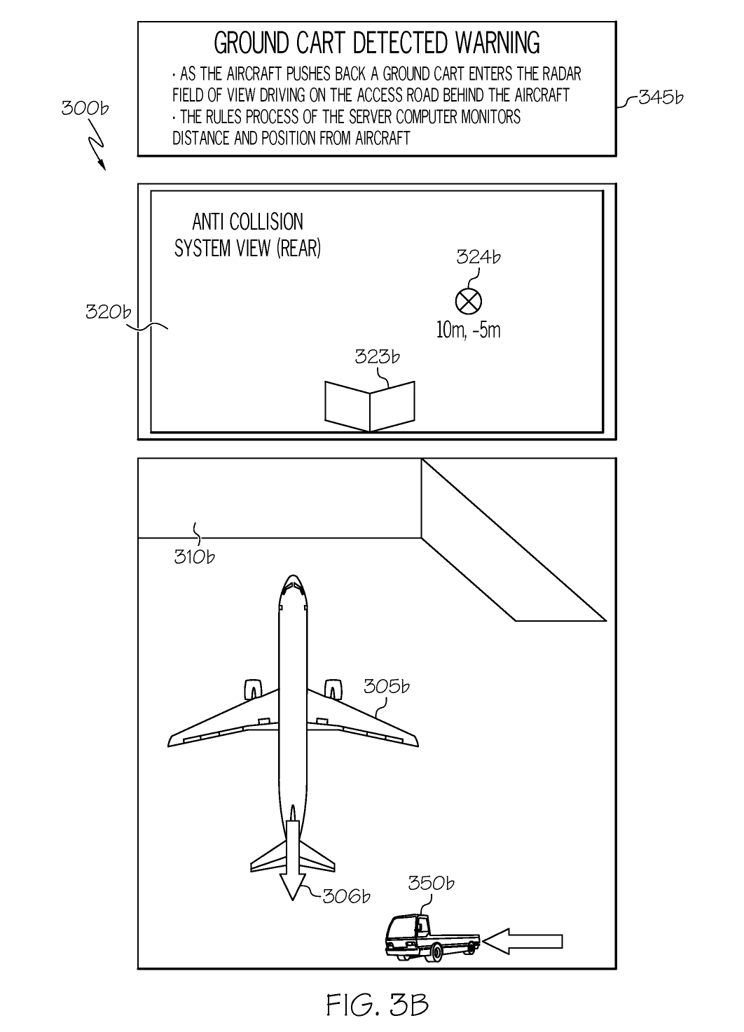

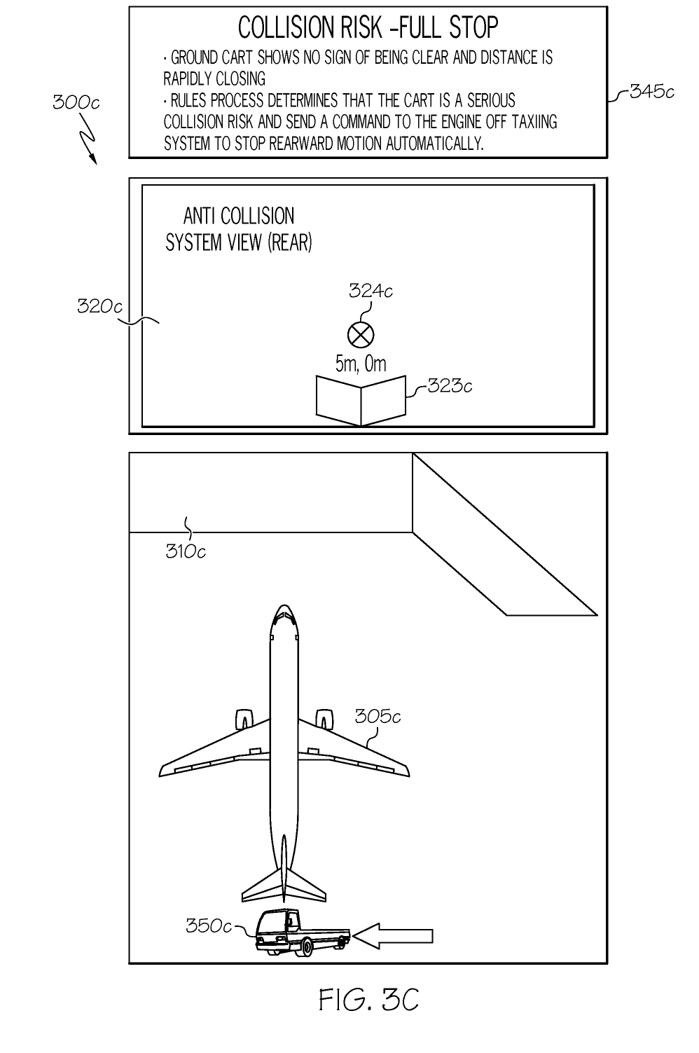

Turning to FIG. 3A, an example implementation of an aircraft pushback method 300a with no obstacles proximate the aircraft 305a is illustrated. The implementation 300a may include, for example, an all-clear condition when aircraft 305a push back begins 345a. An associated anti-collision display 320a may indicate no obstacles 323a detected proximate a rear 306a of the aircraft 305a or adjacent a terminal 310a.

With reference to FIG. 3B, an example implementation of an aircraft pushback method 300b with an obstacle 350b coming into proximity of a rear 306b of aircraft 305b is illustrated. The implementation 300b may include, for example, a ground cart detected warning 345b within a display 320b. For example, the display 320b may include a proximity indicator 324b relative to an aircraft indicator 323b. As can be seen in FIG. 3B, no obstacles are indicated near the terminal 310b. The circumstance indicated in FIG. 3B (e.g., a non-emergency circumstance) may, for example, be when aircraft system 240 controls at least one engines-off taxiing system 215 to automatically maneuver an aircraft to avoid the obstacle.

Turning to FIG. 3C, an example implementation of an aircraft pushback method 300c with an obstacle 350c proximate aircraft 305c is illustrated. The implementation 300c may include, for example, a ground cart emergency 345c within a display 320c. For example, the display 320c may include an emergency indicator 324c relative to an aircraft indicator 323c. As can be seen in FIG. 3C, no obstacles are indicated near the terminal 310c. The circumstance indicated in FIG. 3C (e.g., an emergency circumstance) may, for example, be when a wing-walker activates an emergency stop.

The present method for monitoring autonomous pushback may be designed to monitor pushback in aircraft that are equipped with engines-off taxiing systems for autonomous ground travel. Other systems of aircraft ground travel that do not employ aircraft engines to power aircraft ground movement, such as, for example, remotely controlled devices that may be attached to and detached from one of more aircraft wheels to move an aircraft during ground travel, are also contemplated to be within the scope of the present method. An engines-off taxiing system may include one or more non-engine drive means, that are mounted on one or more nose or main landing gear wheels, to drive the wheels at a desired speed and torque.

While an aircraft's pilot may have the primary control over the engines-off taxiing system during the autonomous accelerated pushback process monitored as described herein, the monitoring system may be adapted so that an airport's Air Navigation Services and Ground Operations Control may also receive information and be capable of exerting some control over an aircraft's autonomous accelerated pushback.

A monitoring method according to the present invention may be able to monitor or survey a maximum portion of the aircraft's external ground environment where potential obstructions are likely to be found and to communicate information about ground environment conditions, including the presence or absence of obstructions, that may impact the safety of the aircraft so that the pilot may control the engines-off taxiing system to appropriately control movement of the aircraft in response. A monitoring method may, in addition, include a monitoring system with a range of different sensors, sensor devices, monitoring devices, and the like that are capable of obtaining and communicating information relating to an aircraft's surroundings during pushback in any visibility or environmental conditions. It is contemplated that sensor systems similar to those currently available for use in automobiles to enable them to back up safely may be adapted or combined with other sensors, sensor devices, and monitors in the monitoring system of the present invention.

For maximum effectiveness, the present method can monitor an aircraft's ground environment at different heights from the tarmac or a ground surface to ensure that a variety of different kinds of potential obstructions may be detected. In accordance with the present method, a plurality of different sensors, sensor devices, and/or monitoring devices may be employed to obtain a maximum amount of information. This enables the aircraft to be guided as safely as possible as it is driven by a pilot, first in a reverse direction away from a terminal or gate and then as the aircraft is pivoted or turned in place to be driven in a forward direction. A monitoring method may have the capability to scan or “sweep” an aircraft's exterior at all times during pushback. Monitoring may be continuous or it may be intermittent, depending in part on the most effective operation of a particular type of sensor or sensor device.

In the present invention, different sensors or sensor devices may be used that are capable of scanning or sweeping an aircraft's exterior, either continuously, intermittently, or in an optimum combination of continuous and intermittent operation. A camera, for example, may operate continuously, while an ultrasound, radar or LiDAR system may be adapted to operate intermittently, as described in more detail below.

This capability will enable the pilot to control operation of the engines-off taxiing system to stop the aircraft at any time when detection of an obstruction is communicated to a system controller and to the cockpit while the aircraft is reversing or pivoting or, if warranted, to stop the pushback process.

In the present invention, the pushback process may be stopped or may not even be instituted if, for example, the present invention is activated prior to the commencement of pushback and detects that, for example, a catering truck is still attached to the aircraft. That information would be communicated, such as through a system controller, to the cockpit through visual and/or audio signals as described below, and the pilot would know to refrain from operating the engines-off taxiing system to drive the aircraft in reverse until removal of the catering truck from the aircraft was confirmed.

The communication of information relating to the aircraft's ground environment from sensors and/or sensor or monitoring devices to an aircraft cockpit and cockpit crew in accordance with the present invention may be accomplished in any one of a number of ways. Visual and/or audio indicators, such as, for example without limitation, selectively colored flashing and/or non-flashing lights and/or selected sounds or tones may be used. A video display may further be employed to show, in real time, the exterior of the aircraft and/or a map of the aircraft's surroundings that may include relative locations and distances of other aircraft and ground vehicles that might pose obstructions or collision threats as the aircraft exterior is “swept” by selected sensors and/or monitoring devices. Other video displays and/or acoustic indicators are known in the art may be used and are contemplated to be within the scope of the present monitoring method.

A plurality of different types of sensors, sensor devices and/or monitoring devices may be used in a monitoring system useful with the present monitoring method. Various kinds of sensors may be employed to provide different or overlapping information about potential hazards in an aircraft's external environment.

A monitoring system useful with the present monitoring method may, for example, include cameras located in positions on the exterior of an aircraft where a complete view all around the aircraft of the ground level environment at different heights above the ground may be obtained. At least one camera may be mounted in the vicinity of the nose landing gear to communicate with the cockpit so that the pilot has a clear view of the aircraft's nose landing gear and a trailing line. A wide angle camera, for example, may be used to provide an optimal view of the area in front of and along the sides of the nose landing gear as the aircraft is driven in reverse to ensure that the nose wheels are following a trailing line. An expansive view of this area may also assist the pilot to stay on the line in the event that the nose wheel must be steered at a sharp angle. Suitable cameras for this purpose are available from, for example Securaplane

Technologies Inc, and other sources. However, at night or in low visibility conditions, standard cameras by themselves may be of limited value in monitoring an aircraft's exterior during autonomous accelerated pushback as described herein.

Additional sensors, sensor devices, monitoring devices, and the like, both digital and analog, that are designed to provide information about objects in or near an aircraft's reverse or turning path are also contemplated for use in a monitoring system with the present monitoring method. These may include, for example without limitation, sonar or ultrasound, LiDAR or LADAR, global positioning (GPS), and/or radar systems, similar to those currently used for enhanced environmental monitoring in automobiles, but specifically adapted for aircraft use. Proximity sensors, which may be attached to locations at the extremities of an aircraft, for example the wing tips, tail, nose, as well as to other aircraft exterior locations may also be used to monitor potential obstructions. The use of a range of different types of sensors, sensor devices, and monitoring devices, rather than relying on a single type of sensor, sensor device, or monitoring device, ensures that a maximum portion of an aircraft's exterior environment will be monitored in all visibility and weather conditions. When the effectiveness of one type of sensor or sensor device is limited as a result of environmental conditions, other sensors or sensor devices are available to monitor an aircraft's exterior and communicate the presence or absence of obstructions in the aircraft's travel path to the cockpit.

It is noted that the term LiDAR, which refers to a light detection and ranging device, is frequently used also to include LADAR, which refers to a Laser Detection and Ranging device. Both acronyms represent remote sensing technology capable of determining the distance between a sensor and an object, in the instant invention the distance between a sensor located on an aircraft and a potential obstruction as the aircraft is driven in reverse during pushback. A highly detailed three-dimensional map of a potential obstruction may be produced by either LiDAR or LADAR, and both may be used as sensor devices to communicate such a map as a visual display to an aircraft cockpit in accordance with the present monitoring method.

Sensors, sensor devices and monitoring devices useful with the present invention may be removably or permanently attached to or embedded in exterior aircraft structures at locations selected to maximize the extent of environmental information obtained during aircraft ground travel, particularly during the accelerated pushback process described herein. These various sensor and sensor devices may be capable of checking for obstructions at a range of heights above a ground surface relative to an aircraft for maximum opportunity to detect structures and/or objects that might interfere with or obstruct aircraft movement. In accordance with the present method, the foregoing sensors or sensor devices may be adapted to continuously monitor an aircraft's exterior environment prior to pushback and during pushback as the aircraft reverses and turns. Alternatively, these sensors and sensor devices may be adapted to intermittently monitor the aircraft exterior environment. Radar and LiDAR or LADAR systems, for example, may be programmed to release, respectively, a burst of microwave or laser energy at random or at selected intervals to detect potential obstructions in an aircraft's reverse pushback or turn path.

When a combination of different sensor devices is used to monitor and obtain information about an aircraft's external ground environment as described herein, limitations of one particular type of sensor device may be compensated for by a different type of sensor device. As noted above, cameras are minimally effective in low visibility conditions. Ultrasound sensor devices may also be affected by atmospheric temperature and pressure. The additional use of a radar or LiDAR or LADAR sensor device or proximity sensors, for example, allows the detection of objects near an aircraft when visibility is low or weather conditions interfere with the transmission of sound waves. In an additional example, when the aircraft pilot is preparing the engines-off taxiing system for reverse movement or is driving the aircraft in reverse, “bursting” by a radar system could check for potential obstructions not necessarily visible to a camera under low visibility conditions or at other times. One or more LiDAR or LADAR devices may be adapted and positioned to scan or “sweep” the sides and rear of an aircraft at different heights or levels above the ground as described above and provide a map of the aircraft's surroundings. Different types of sensors or sensor devices may additionally be positioned in different aircraft exterior locations and/or at different heights above the ground surface to maximize the extent of the exterior space around the aircraft that is being monitored.

It is further contemplated in the present invention that a cooperative arrangement of non-visual sensing devices may be provided on the airport ground surface or tarmac and on the aircraft. A trailing line, for example, may, instead of a conventional painted line, be a linear array of indicators positioned to define an optimum aircraft reverse travel path. The linear array of indicators may also be used to guide aircraft forward travel into the terminal. One or more sensors designed to detect the ground surface indicators may be mounted on the aircraft in locations where the positions of such indicators may be detected as the aircraft is driven in reverse by the pilot-controlled engines-off taxiing system. A cockpit indicator, such as, for example, an audible or visual signal, may be provided to warn the pilot in the event that the aircraft strays from the travel path so that the pilot may take appropriate action to return the aircraft to a trailing line . Other arrangements of cooperative non-visual ground level indicators and aircraft-mounted sensors may also be employed to ensure that an aircraft travels in reverse along an optimum path in an autonomous accelerated pushback process as described herein.

The automated gate docking systems currently available at many airports and used to signal the arrival of an aircraft may additionally be used to monitor movement of an aircraft in reverse by a pilot-controlled engines-off taxiing system during the autonomous accelerated pushback process described herein. These automated systems may be modified, if required, to provide information to the pilot about the aircraft's distance from a gate as the aircraft is reversed, as well as information about the aircraft's position where a turn may be started.

It is additionally contemplated that appropriate software may be adapted to integrate information from a range of different types of sensors or sensor devices to provide continuous real time information to a system controller and to an aircraft pilot before and during autonomous accelerated pushback in a video display or in another form as described above.

The present monitoring method is intended to facilitate and maximize safety as an aircraft equipped with an engines-off taxiing system autonomously pushes back from an airport terminal or gate using the streamlined accelerated pushback process described above. The aircraft is additionally equipped with a monitoring system that may include a plurality of different types of sensors and/or sensor devices positioned on the aircraft exterior in locations selected to monitor a maximum amount of the ground environment and space surrounding the aircraft. The monitoring system is further designed to inform the pilot when obstructions are detected that would prevent the aircraft from reversing and turning safely. When the aircraft has been cleared for pushback, the pilot ensures that the monitoring system is functioning and activates and controls the engines-off taxiing system to drive the aircraft in reverse so that the aircraft may back up or reverse from a terminal or gate to a location where it may pivot safely and then drive forward away from the gate. The monitoring system operates continuously or intermittently while the pilot is driving the aircraft in reverse and then turning to scan and/or “sweep” the area around the aircraft and communicates to the cockpit the presence of objects detected in the aircraft's reverse travel path. The monitoring system may additionally visually or non-visually monitor the reverse travel of the aircraft along a trailing line as described above. The pilot can control operation of the engines-off taxiing system to keep the aircraft on an optimum reverse travel path or to stop or slow the aircraft, as appropriate.

The monitoring system of the present invention may also be adapted to bypass pilot control of the engines-off taxiing system and stop movement of the aircraft if, for example, a pilot has not responded to an obstruction indication communicated to a system controller and/or to the cockpit, and the monitoring system senses that collision is imminent. In the event that a sensor senses an obstruction that is too close to the aircraft, that information may be communicated to a monitoring system controller, which may be designed to interact directly with the aircraft engines-off taxiing system to automatically prevent the taxiing system from moving the aircraft. If the aircraft is already moving when one or more sensors senses an obstruction or a potential for collision, the monitoring system controller may be designed with the capability to stop the engines-off taxiing system, apply the aircraft's brakes, or take whatever action is needed to stop the aircraft from moving. It is also contemplated that information relating to such an obstruction or potential for collision may be sent to Air Navigation Services and Ground Operations Control at an airport to provide a record of the event if an investigation is required. The foregoing example is merely illustrative, and it is contemplated that a range of monitoring systems and/or system controllers may be useful with the present monitoring method to monitor an aircraft's exterior ground environment during an autonomous accelerated aircraft pushback process and to provide information and feedback to a pilot of the aircraft so that the safety of the pushback process is maximized.

It should be understood, of course, that the foregoing relates to exemplary embodiments of the invention and that modifications may be made without departing from the spirit and scope of the invention as set forth in the following claims.

1. An aircraft anti-collision system for use in taxiing an aircraft on a surface around an airport terminal, the system comprising:
a plurality of sensors communicatively coupled to a controller, wherein the plurality of sensors are configured to detect obstacles proximate the aircraft; and
a first engines-off taxiing system and a second engines-off taxiing system communicatively coupled to the controller, wherein the controller is configured to control the first engines-off taxiing system and the second engines-off taxiing system to maneuver the aircraft in response to signals received, by the controller, from the plurality of sensors, wherein maneuvering the aircraft includes steering the aircraft by applying torque to at least one first landing gear wheel in a first direction via the at least one first engines-off taxiing system, and applying torque to at least one second landing gear wheel in a second direction via the at least one second engines-off taxiing system, wherein the first direction is rotationally opposite the second direction;
wherein at least one of the sensors is configured to determine whether an obstacle has a height lower than an element of aircraft structure so that the element of aircraft structure can pass over said obstacle.

2. The system of claim 1, further comprising:
a mobile terminal having an emergency stop button, wherein the mobile terminal is wirelessly coupled to the controller, and wherein the emergency stop button is configured to be activated by a ground crew individual in circumstances where collision of the aircraft with an obstacle is imminent.

3. The system of claim 1, wherein the controller is configured to automatically control the at least one first engines-off taxiing system and the at least one second engines-off taxiing system to maneuver the aircraft in circumstances where collision of the aircraft with an obstacle is not imminent.

4. The system of claim 1, further comprising:
a mobile terminal having an emergency stop button, wherein the mobile terminal is wirelessly coupled to the controller, and wherein the emergency stop button is configured to be activated by a ground crew individual in circumstances where collision of the aircraft with an obstacle is imminent, wherein the at least one first engines-off taxiing system includes a first hydraulic brake and the at least one second engines-off taxiing system includes a second hydraulic brake, and wherein activation of the emergency stop button activates the first and second hydraulic brakes.

5. The system of claim 1, wherein the plurality of sensors includes at least one sensor selected from: a camera, a proximity sensor, an ultrasound sensor, a radar sensor, a LiDAR sensor, a sonar sensor, a LADAR sensor, or a global positioning system (GPS).

6. The system of claim 1, further comprising:
a cockpit display and a pilot override button, wherein the pilot override button is configured to override all other functions of the system.

7. An aircraft anti-collision system for use in taxiing an aircraft on a surface around an airport terminal, the system comprising:
a plurality of sensors communicatively coupled to a controller, wherein the plurality of sensors are configured to detect obstacles proximate the aircraft;
an engines-off taxiing system communicatively coupled to the controller, wherein the controller is configured to control the engines-off taxiing system to maneuver the aircraft in response to signals received, by the controller, from the plurality of sensors, wherein maneuvering the aircraft includes steering, stopping and accelerating the aircraft; and
an automated gate docking system modified to provide information to a pilot about an aircraft's distance from a gate and when a turn may be started as the aircraft is reversed by the ermines-off taxiing system.

8. The system of claim 7, further comprising:
a mobile terminal having an emergency stop button, wherein the mobile terminal is wirelessly coupled to the controller, and wherein the emergency stop button is configured to be activated by a ground crew individual in circumstances where collision of the aircraft with an obstacle is imminent.

9. The system of claim 7, wherein the controller is configured to automatically control the at least one engines-off taxiing system to maneuver the aircraft in circumstances where collision of the aircraft with an obstacle is not imminent.

10. The system of claim 7, further comprising:
a mobile terminal having an emergency stop button, wherein the mobile terminal is wirelessly coupled to the controller, and wherein the emergency stop button is configured to be activated by a ground crew individual in circumstances where collision of the aircraft with an obstacle is imminent, wherein the at least one engines-off taxiing system includes a hydraulic brake, and wherein activation of the emergency stop button activates the hydraulic brake.

11. The system of claim 7, wherein the at least one engines-off taxiing system includes at least one electric motor that is configured to apply torque, to at least one landing gear wheel, in two rotationally oriented directions.

12. The system of claim 7, wherein the plurality of sensors includes at least one sensor selected from: a camera, a proximity sensor, an ultrasound sensor, a radar sensor, a LiDAR sensor, a sonar sensor, a LADAR sensor, or a global positioning system (GPS).

13. The system of claim 7, further comprising:
a cockpit display and a pilot override button, wherein the pilot override button is configured to override all other functions of the system.

14. An aircraft anti-collision system for use in taxiing an aircraft on a surface around an airport terminal, the system comprising:
a plurality of sensors communicatively coupled to a controller, wherein the plurality of sensors are configured to detect obstacles proximate the aircraft;
a camera configured to provide a pilot with a view of the aircraft's nose landing gear and a trailing line so that the pilot can ensure that the nose wheels follow the trailing line;
an engines-off taxiing system communicatively coupled to the controller, wherein the controller is configured to control the engines-off taxiing system to maneuver the aircraft in response to signals received, by the controller, from the plurality of sensors; and
an emergency stop button that is configured to be activated by a ground crew individual in circumstances where collision of the aircraft with an obstacle is imminent, wherein the engines-off taxiing system includes a hydraulic brake, and wherein activation of the emergency stop button activates the hydraulic brake.

15. The system of claim 14, wherein the controller is configured to automatically control the at least one engines-off taxiing system to maneuver the aircraft in circumstances where collision of the aircraft with an obstacle is not imminent.

16. The system of claim 14, wherein the at least one engines-off taxiing system includes at least one electric motor and at least one hydraulic brake, wherein the controller is configured to prevent applying torque to a landing gear wheel via the at least one electric motor while applying the hydraulic brake.

17. The system of claim 14, wherein the at least one engines-off taxiing system includes at least one electric motor that is configured to apply torque, to at least one landing gear wheel, in two rotationally oriented directions that are different from one another.

18. The system of claim 14, wherein the plurality of sensors includes at least one sensor selected from: a camera, a proximity sensor, an ultrasound sensor, a radar sensor, a LiDAR sensor, a sonar sensor, a LADAR sensor, or a global positioning system (GPS).

19. The system of claim 14, further comprising:
a cockpit display and a pilot override button, wherein the cockpit display is configured to display detected obstacles, and wherein the pilot override button is configured to override all other functions of the system.

20. The system of claim 14, wherein the at least one engines-off taxiing system includes at least one electric motor and at least one hydraulic brake, wherein the controller is configured to apply torque to a landing gear wheel via the at least one electric motor to stop the aircraft under non-emergency circumstances, and wherein the controller is configured to activate the hydraulic brake to stop the aircraft under emergency circumstances
